(19) United States
(12) Patent Application Publication
(10) Pub. No.: US 2016/0196701 A1
(43) Pub. Date: Jul. 7, 2016

(54) FLEET MANAGEMENT AND CROWD DISTRIBUTION OF MAINTENANCE TASKS

(71) Applicant: Porter & Strother, LLC, Ann Arbor, MI (US)

(72) Inventors: ANSGAR STROTHER, Ann Arbor, MI (US); Carl Vitullo, Ann Arbor, MI (US)

(21) Appl. No.: 14/975,099

(22) Filed: Dec. 18, 2015

Related U.S. Application Data
(60) Provisional application No. 62/094,579, filed on Dec. 19, 2014.

(51) Int. Cl. G07C 5/08; G07C 5/00

(52) U.S. Cl. CPC G07C 5/0808; G07C 5/008; G07C 5/006

(57) ABSTRACT

To keep a bicycle fleet in good working condition, a bicycle sharing system may employ a fleet management and maintenance system. The various modules and databases of the fleet management and maintenance system coordinate with one another to contribute to an efficient bicycle sharing system. The fleet management and maintenance system may include a task creation module that can detect, create, and schedule maintenance tasks based on bicycle maintenance information. The fleet management and maintenance system may also include a notification module. After the task creation module creates a maintenance task, the notification module selects one or more maintenance providers for notification of the maintenance task. The fleet management and maintenance system may also include a maintenance verification module that determines the probability that a maintenance task completed by the assigned maintenance provider has not been satisfactorily performed and requires further verification.

### CROSS-REFERENCE TO RELATED PATENT APPLICATIONS

This application claims priority to and the benefit of U.S. Provisional Patent Application No. 62/094,579, filed Dec. 19, 2014, the entire disclosure of which is incorporated by reference herein.

### BACKGROUND

Bicycle sharing systems provide communities with green public transportation alternatives. Bicycle sharing systems may have employees conduct random spot checks, report non-specific issues, and perform routine scheduled maintenance. However, the method of having employees visit bicycle rental stations to randomly check and maintain bicycles is inefficient. First, employees may overlook bicycle issues. Furthermore, repeat visits by one or more employees to fix one bicycle may be necessary when the bicycle requires replacement parts not available during prior visits or when an employee with greater mechanic expertise is needed to fix the bicycle. Without an efficient and cost effective maintenance system, a bicycle sharing system incurs high maintenance cost, especially in areas where the maintenance workload does not merit the employment of a full-time maintenance staff.

Consequently, operators of bicycle sharing systems need to determine when bicycles in the systems require maintenance efficiently and effectively. If an operator of a bicycle sharing system knows the probability that a particular bicycle in the bicycle sharing systems requires maintenance, the operator is more able to direct maintenance resources to the bicycle while taking into consideration the maintenance needs of all the bicycles in the bicycle sharing system. In addition, operators of bicycle sharing systems need to be able to efficiently and effectively notify maintenance providers of the maintenance needs of bicycles in the bicycle sharing systems. An operator of a bicycle sharing system needs the ability to identify maintenance providers who are able and willing to satisfy the maintenance needs of bicycles in the system. Operators of bicycle sharing systems must be able to more efficiently verify that maintenance providers have satisfactorily completed maintenance tasks. Furthermore, an operator of a bicycle sharing system needs to know the probabilities that particular maintenance tasks have been satisfactorily completed by maintenance providers in order to efficiently direct resources to confirm the completions of particular maintenance tasks in the system that require verifications.

### SUMMARY

The present disclosure relates generally to the field of shared transit vehicles. More specifically, the present disclosure relates to the management and maintenance of shared vehicles such as bicycles, tricycles, and electric motorcycles. To keep a bicycle fleet in good working condition, a bicycle sharing system may employ a fleet management and maintenance system. The various modules and databases of the fleet management and maintenance system coordinate with one another to contribute to an efficient bicycle sharing system.

The fleet management and maintenance system may include a task creation module that can detect, create, and schedule maintenance tasks based on bicycle maintenance information. The task creation module receives bicycle maintenance information related to the probability of each bicycle in the bicycle sharing system requiring maintenance. Bicycle maintenance information may include crowd-sourced user feedback from non-renters, renters, and maintenance providers of all skill levels. Based on the received bicycle maintenance information, the task creation module generates a maintenance task confidence value that is related to the probability that a bicycle in the bicycle sharing system requires maintenance. The task creation module may compare the determined maintenance task confidence value to a task creation threshold in deciding whether to create a maintenance task for the bicycle.

The fleet management and maintenance system may also include a notification module. After the task creation module creates a maintenance task, the notification module selects one or more maintenance providers for notification of the maintenance task based, in part, on the difficulty levels of maintenance tasks and the capabilities of maintenance providers. The task creation module communicates the created maintenance task to one or more potential maintenance providers. The notification module assigns the maintenance task to one of the notified maintenance providers based on the responses of the notified maintenance providers.

The fleet management and maintenance system may also include a maintenance verification module to determine the probability that a maintenance task completed by the assigned maintenance provider has not been satisfactorily performed and requires verification. In determining the probability that a maintenance task has been satisfactorily completed, the maintenance verification module considers the past performance of the assigned maintenance provider and the difficulty level of the maintenance task. Based on the determined probability, maintenance verification module determines the timing and need to verify a maintenance task performed.

### BRIEF DESCRIPTION OF THE DRAWINGS

FIG. 1 shows an exemplary bicycle sharing system with a fleet management and maintenance system.

FIG. 2 shows another exemplary bicycle sharing system with a fleet management and maintenance system.

FIG. 3 shows a flowchart illustrating one technique of creating a maintenance task.

FIG. 4 shows a flowchart illustrating another technique of creating a maintenance task.

FIG. 5 shows a flowchart illustrating another technique of creating a maintenance task.

FIG. 6 shows a flowchart illustrating another technique of creating a maintenance task.

FIG. 7 shows a flowchart illustrating another technique of creating a maintenance task.

FIG. 8 shows a flowchart illustrating one technique of selecting and notifying a maintenance provider to perform a maintenance task.

### DETAILED DESCRIPTION

Detailed embodiments of the invention are disclosed herein. The disclosed embodiments are merely exemplary that may be embodied in various alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the concepts described herein.

All systems and all modules may be hosted on one server. Alternatively, all modules of a system and the system may be hosted on one server that does not host another system. Alternatively, each system may be hosted on multiple servers in one network or distributed over a network. Each of the repositories and databases disclosed herein may be implemented using proprietary databases or standard database software such as MySQL, Oracle DB, and Microsoft SQL Server. Each database may be hosted locally, distributed over a network, or hosted on the cloud. The information stored in a repository or database may be obtained using one or more of the following: web crawlers; non-renters, renters, and maintenance providers; and one or more operators of the repository, database, or system. These repositories and databases may be updated periodically either automatically or manually.

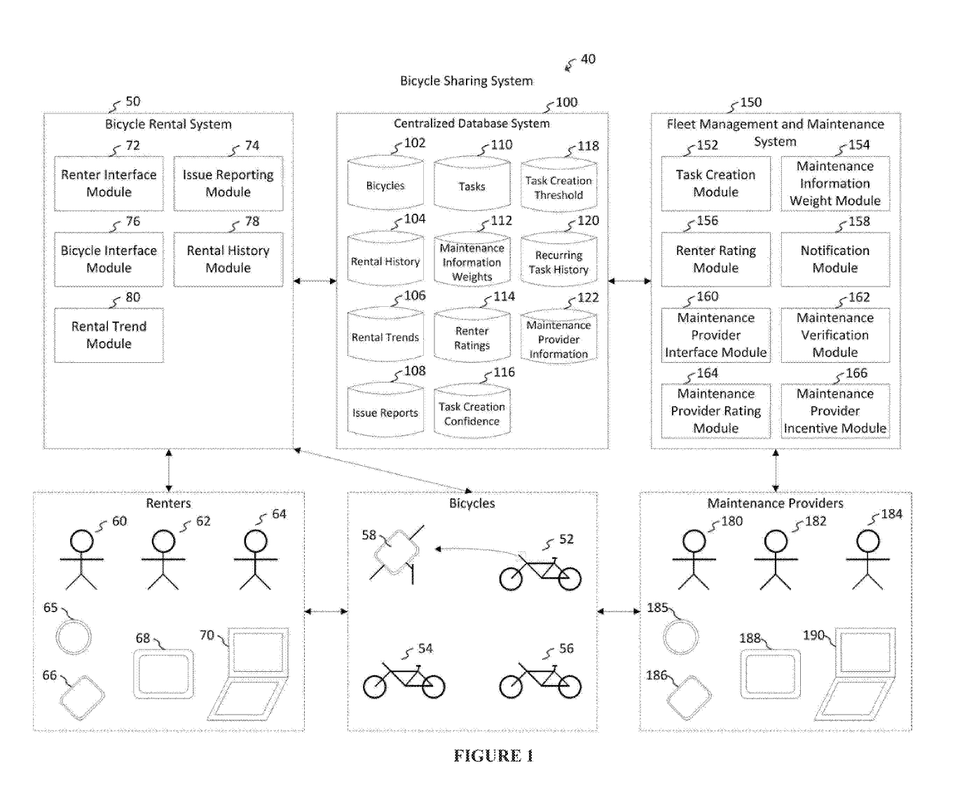

FIG. 1 shows a bicycle sharing system. Bicycle Sharing System 40 employs Bicycle Rental System 50 to manage the rental of one or more bicycles in the fleet rented out by Bicycle Sharing System 40. Bicycle Rental System 50 manages the rental of one or more bicycles, such as Bicycles 52, 54, and 56, at one or more rental stations (not shown) of Bicycle Sharing System 40. Every bicycle managed by Bicycle Sharing System 40 may have a unique identification code that renters, non-renters, and maintenance providers, Bicycle Rental System 50, and Fleet Management and Maintenance System 150 use to identify the bicycle. An electronic control may be attached to each of the managed bicycles. For example, Electronic Control 58 may be attached to Bicycle 52. Electronic Control 58 controls a locking mechanism (not shown) that secures Bicycle 52 to a rental station of Bicycle Sharing System 40 when Bicycle 52 is not in use and in repair. The locking mechanism that secures Bicycle 52 to a rental station may be a component of Bicycle 52. Alternatively, the locking mechanism may be a component of the rental station. Bicycles 52, 54, and 56 may be secured to the same or different rental stations.

Multiple renters, such as Renters 60, 62, and 64, may rent out bicycles managed by Bicycle Rental System 50. When a renter, such as Renter 60, is interested in renting a bicycle, such as Bicycle 52, Renter 60 pays Bicycle Rental System 50 the rental cost of renting Bicycle 52. Renter 60 may pay for bicycle rental via Electronic Control 58, and mobile and wearable devices such as Smart Watch 65, Mobile Phone 66, and Tablet 68, Computer 70, or a Kiosk at the rental station where Bicycle 52 is. After Bicycle Rental System 50 receives rental payment, Electronic Control 58 causes the locking mechanism securing Bicycle 52 to the rental station where Bicycle 52 is to release Bicycle 52. After Bicycle 52 is returned to a rental station, Electronic Control 58 activates a locking mechanism to secure Bicycle 52 to the rental station. Renter 60 may return Bicycle 52 to the rental station where Renter 60 first receives Bicycle 52. Alternatively, Renter 60 may return Bicycle 52 to a different rental station.

Bicycle Rental System 50 comprises one or more of the following modules: Rental Interface Module 72, Issue Reporting Module 74, Bicycle Interface Module 76, Rental History Module 78, and Rental Trend Module 80. Rental Interface Module 72 provides the interface that renters use to interact with Bicycle Sharing System 40. Renters may use Electronic Control 58, mobile and wearable devices such as Smart Watch 65, Mobile Phone 66, and Tablet 68, Computer 70, or one or more Kiosks at one or more rental stations to access the renter interface provided by Rental Interface Module 72. Bicycle Renter System 50 may provide renter interface in the form of one or more websites and mobile applications. Renters may also access the Renter Interface Module 72 by calling one or more support lines of Bicycle Rental System 50.

Issue Reporting Module 74 records and processes issues with rental bicycles reported by renters and non-renters. Renters can report issues with rental bicycles by accessing Issue Reporting Module 74 via Renter Interface Module 72. Non-renters can also report issues with rental bicycles by accessing Issue Reporting Module 74. Bicycle Interface Module 76 monitors the performance of bicycles. For example, each bicycle may be attached with one or more sensors that measure the performance of bicycles such as brake performance, tire pressure, travel speed, shock sustained, acceleration, vibration during use, and weather exposure. Rental History Module 78 records each rental and keeps track of the rental history of each bicycle, such as the frequency and duration of each rental event. Rental Trend Module 80 predicts the rental trend at each rental station, taking into consideration the rental history of each bicycle at each rental station, rental history of all bicycles of Bicycle Sharing System 40, and weather forecast.

Bicycle Rental System 50 may store all data used by the system and data related to bicycles in the fleet managed by the Bicycle Sharing System 40 in Centralized Database System 100. Centralized Database System 100 comprises one or more of the following databases: Bicycles database 102, Rental History database 104, Rental Trends database 106, Issue Reports database 108, Tasks database 110, Maintenance Information Weights database 112, Renter Information database 114, Task Creation Confidence database 116, Task Creation Threshold database 118, Recurring Task History database 120, and Maintenance Provider Information database 122. Bicycles database 102 maintains a list of bicycles managed by Bicycle Sharing System 50. Rental History database 104 maintains the rental history of bicycles managed by Bicycle Sharing System 50. Rental Trends database 106 keeps track of rental trends, both predicted and recorded. Issue Reports database 108 stores issues with rentals bicycles submitted by non-renters, renters, and maintenance providers using Issue Reporting Module 74.

Fleet Management and Maintenance System 150 keeps the bicycles in the fleet managed by Bicycle Sharing System 40 in good working condition by ensuring that all necessary maintenance services are timely performed. Fleet Management and Maintenance System 150 comprises one or more of the following modules: Task Creation Module 152, Maintenance Information Weight Module 154, Notification Module 158, Maintenance Provider Interface Module 160, Maintenance Verification Module 162, Maintenance Provider Rating Module 164, and Maintenance Provider Incentive Module 166.

Task Creation Module 152 creates maintenance tasks for bicycles in the fleet to ensure the bicycles in the fleet are in good working conditions. Maintenance Information Weight Module 154 keeps track and updates the weights Task Creation Module 152 use in creating maintenance tasks. Notification Module 158 selects and notifies one or more maintenance providers, such as Maintenance Providers 180, 182, and 184, of maintenance tasks. Maintenance Provider Interface Module 160 provides the interface that allows the notified providers to access the notifications and maintenance tasks using mobile and wearable devices such as Smart Watch 185, Mobile Phone 186, and Tablet 188, Computer 190, or one or more Kiosks at one or more rental stations. Fleet Management and Maintenance System 150 may provide the interface in the form of one or more websites and mobile applications. Maintenance providers may also access the Maintenance Provider Interface Module 72 by calling one or more support lines of Fleet Management and Maintenance System 150. Maintenance providers may also use Maintenance Provider Interface Module 160 and Issue Reporting Module 74 to report issues with rental bicycles. Even though Notification Module 158 may notify more than one maintenance providers of a particular maintenance task, only one maintenance provider will be assigned the particular maintenance task, possibly depending on the availability of the notified maintenance providers. Maintenance Verification Module 162 ensures that the maintenance tasks are properly performed by maintenance providers. For each maintenance task, after the assigned maintenance provider notifies Fleet Management and Maintenance System 150 the maintenance task has been completed on the bicycle, the Maintenance Verification Module 162 may create one or more verification tasks for the completed maintenance task. A verification task may request one or more subsequent renters confirm that the bicycle is in good working condition. Alternatively, a verification task may request one or more maintenance providers who did not perform the maintenance task to confirm the maintenance task has been satisfactorily performed. Based in part on the verification history of each maintenance provider, Maintenance Provider Rating Module 164 determines the rating of each maintenance provider. Provider Incentive Module 166 incentivizes maintenance providers to properly perform maintenance tasks in a timely manner.

Task Creation Module 152 determines a maintenance task confidence value for every maintenance task of every bicycle. If a maintenance task of a bicycle has a maintenance task confidence value greater than a task creation threshold value of the maintenance task, Task Creation Module 152 creates a maintenance task for the bicycle. Each maintenance task may have an associated difficulty level, possibly assigned by Task Creation Module 152.

Notification Module 158 may alert only those maintenance providers authorized to perform the particular type maintenance task and the difficulty level of the particular maintenance task. Notification Module 158 may take into account the capabilities and ratings of maintenance providers, both possibly determined by Maintenance Provider Rating Module 164, in selecting maintenance providers to notify.

For every maintenance task, Notification Module 158 may consider the locations of maintenance providers and the location of maintenance task, i.e. the location of the bicycle requiring the performance of the maintenance task, in selecting maintenance providers to notify of the maintenance task. Notification Module 158 may notify only maintenance providers that are presently within a certain distance of the bicycle with an associated maintenance task. The location of a maintenance provider may be the GPS location of the maintenance provider. Smart Watch 185, Mobile Phone 186, Tablet 188, or Computer 190 that a maintenance provider carries may provide the GPS capability for determining the location of the maintenance provider. Alternatively, Notification Module 158 may notify only maintenance providers that have been notified of or assigned one or more maintenance tasks within a certain distance of the bicycle with a maintenance task being considered for notification.

Maintenance Verification Module 162 assists Fleet Management and Maintenance System 150 in determining whether a maintenance task completed by a maintenance provider requires verification of the completion and quality of the maintenance task performed. When Maintenance Verification Module 162 determines that a maintenance task requires verification, a maintenance provider, possibly a senior maintenance provider, may be dispatched to confirm the completion and quality of the maintenance task performed. Alternatively, Maintenance Verification Module 162 may request one or more subsequent renters to verify that a bicycle with a completed maintenance task is in good working condition. Maintenance Verification Module 162 may take into account the task history of the maintenance provider performing the maintenance task in determining whether a completed maintenance task requires verification. Other criteria Maintenance Verification Module 162 may consider in determining whether verification is required for a completed maintenance task includes the maintenance provider's past verification history, the ratings of renters and maintenance providers verifying the maintenance provider's previous completed maintenance tasks, the capability of the maintenance provider, and the difficult level of the maintenance task.

Maintenance Provider Rating Module 164 keeps track and provides ratings for maintenance providers. Criteria Maintenance Provider Rating Module 164 considers in rating maintenance providers may include crowd-sourced numerical feedback from renters of Bicycle Sharing System 40, written feedback from renters, and ratings of maintenance provider performing task verification. Maintenance Provider Rating Module 164 may exclude feedback from renters with confirmed inaccurate feedback history.

Fleet Management and Maintenance System 150 may store all data related to the management and maintenance of bicycles in the fleet managed by Bicycle Sharing System 40 in Centralized Database System 100. Tasks database 110 keeps track of all the maintenance tasks created for and performed on bicycles managed by Bicycle Sharing System 40. Maintenance Information Weights database 112 stores the different weights assigned to different types and sources of reports and various types of bicycle maintenance information used in calculating maintenance task confidence value. Renter Information database 114 keeps track of the ratings of renters. Task Creation Confidence database 116 stores the confidence value of each maintenance task for each bicycle in the fleet managed by Bicycle Sharing System 40. Task Creation Threshold database 118 keeps track of the threshold confidence levels required for creating the numerous types of maintenance tasks. Recurring Task History database 120 stores the information concerning the history of recurring tasks performed on each bicycles in the fleet managed by Bicycle Sharing System 40. Maintenance Provider Information database 122 stores the qualifications, capabilities, and ratings of maintenance providers of Bicycle Sharing System 40.

Bicycle Rental System 50 and Fleet Management and Maintenance System 150 may be connected to one or more networks. And each network may be a local area network (LAN), a virtual private network (VPN), a wide area network (WAN), or the Internet. Each network may utilize one or more network protocols such as TCP/IP and IEEE 802.11 for communication. Electronic Control 58, Smart Watches 65 and 185, Mobile Phones 66 and 186, Tablets 68 and 188, and Computers 70 and 190, or the one or more Kiosks at the one or more rental stations are connected to Bicycle Rental System 50 and Fleet Management and Maintenance System 150 through the one or more networks, allowing Renters 60, 62, and 64 and Maintenance Providers 180, 182, and 184 to interact with the systems.

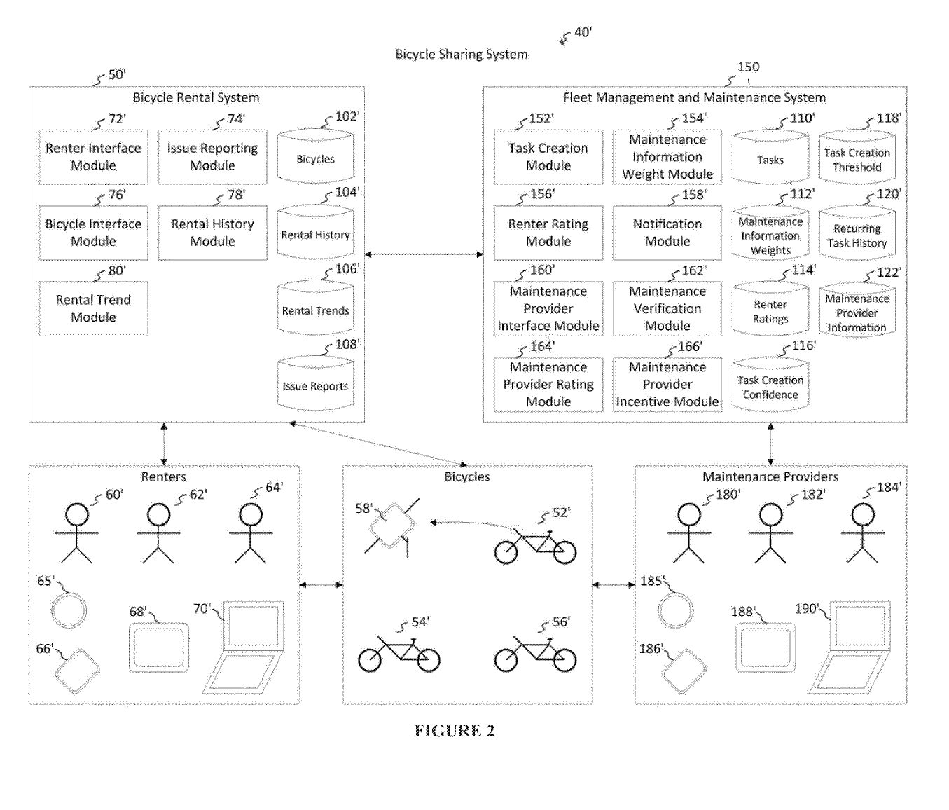

FIG. 2 shows another bicycle sharing system, Bicycle Sharing System 40, employing Bicycle Rental System 50 and Fleet Management and Maintenance System 150 to manage the rental and maintenance of one or more bicycles in the fleet managed by Bicycle Sharing System 40. In contrast to the bicycle sharing system illustrated in FIG. 1 that includes Centralized Database System 100 that stores and manages all data on the rental, management, and maintenance of bicycles managed by the bicycle sharing system, Bicycle Sharing System 40′ illustrated in FIG. 2 does not include a centralized database system. Bicycle Rental System 50′ of Bicycle Sharing System 40′ may include one or more of the following databases: Bicycles database 102′, Rental History database 104′, Rental Trends database 106′, and Issue Reports database 108′. Fleet Management and Maintenance System 150′ may include one or more of the following databases: Tasks database 110′, Maintenance Information Weights database 112′, Renter Information database 114′, Task Creation Confidence database 116′, Task Creation Threshold database 118′, Recurring Task History database 120′, and Maintenance Provider Information database 122′. One or more databases hosted on Bicycle Rental System 50′ and Fleet Management and Maintenance System 150′ may be replicated to one or more database servers, possibly a centralized database system, to improve data availability and security.

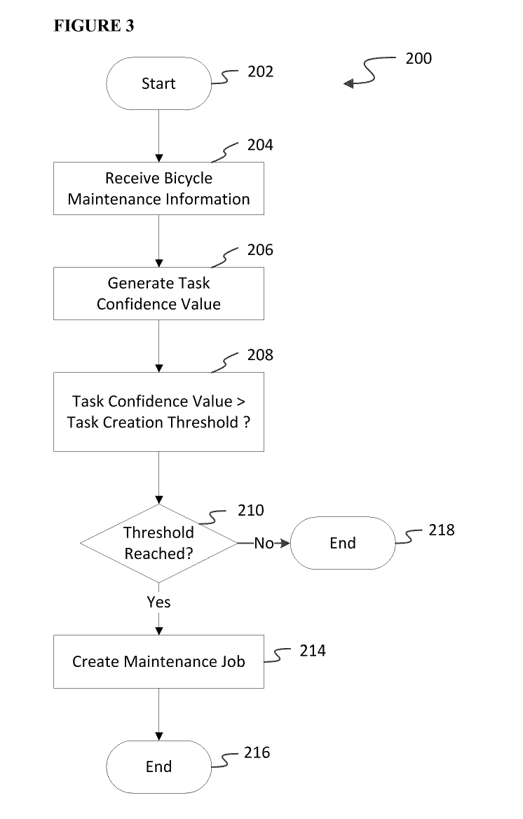

FIG. 3 is a flowchart illustrating technique 200, possibly employed by Task Creation Module 152, for creating maintenance tasks based on reported issues. Technique 200 starts at 202. At 204, the technique receives one or more reports from non-renters, renters, and maintenance providers. The technique may receive a “negative” report when a bicycle has been rented and returned without any reported issue. A renter may report that a bicycle has an issue after renting or attempting to rent a bicycle using Electronic Control 58, Smart Watch 65, Mobile Phone 60, Tablet 62, Computer 74, or one or more Kiosks at a rental station to access Renter Interface Module 72 and Issue Reporting Module 74. A maintenance provider may also report that a bicycle has an issue using Smart Watch 185, Mobile Phone 186, Tablet 188, Computer 190, or one or more Kiosks at a rental station to access Maintenance Provider Interface Module 160 and Issue Reporting Module 74. Issue Reports database 108 keeps track of the issues reported.

At 206, the technique generates maintenance task confidence values for each possible maintenance task of each bicycle managed by Bicycle Sharing System 40. A bicycle with a high maintenance task confidence value likely requires maintenance. In computing a maintenance task confidence value, the various types of issue reports may be given different maintenance information weights. Maintenance Information Weights database 112 may keep track of the different weights the various types and sources of issue reports in calculating confidence values determined and updated by Maintenance Information Weight Module 154. For example, when a non-renter reports that a bicycle has an issue, the issue report is assigned a low weight in calculating a maintenance task confidence value. Alternatively, the maintenance information weight of an issue report may be the rating of the non-renter, renter, or maintenance provider reporting the issue. Alternatively, the maintenance information weight of an issue report may the rating of the non-renter renter, or maintenance provider reporting the issue exponentially-weighted by a time factor. For example, the time factor may be ê(T_issue report−T_present) where T_issue_report is the time when the Fleet Management and Maintenance System 150 receives the issue report and T_present is the time when the technique calculates the maintenance task confidence values. Weight Maintenance Information Weight Module 154 may update maintenance information weights when the ratings of non-renters, renters, and maintenance providers are updated.

Renter Rating Module 154 may update renter ratings based on the relative accuracy of the report history of the renter. The Renter Rating Module 156 may keep track of maintenance information weights in Renter Information database 114. Renter Rating Module 156 keeps track and cross-references bicycle issue reports stored in Issue Reports database 108 with maintenance task creation to determine if a given renter's issue reports are trustworthy. Renter Rating Module 156 determines the likelihood that a given renter's reported issue will actually result in the creation of a maintenance task based upon the renter's past reports issue reports.

Renter Rating Module 156 may monotonically increase the reporter's renter rating for each accurate report reported by the reporter and decrease the reporter's renter rating or reset the reporter's renter rating to a base level for submitting an inaccurate report. So if renter ratings are in the range of one to ten and the renter rating increases with increment is one, then Renter Rating Module 156 may increase the reporter's renter rating by one for each accurate report and reset it to one in the event of an inaccurate report. Maintenance Provider Rating Module 164 may also determine the ratings of maintenance providers, possibly stored in Maintenance Provider Information database 122 based on the accuracy of the issue reports by maintenance providers. The ratings of non-renters may be similarly determined.

Alternatively, the rating of a renter and the weight of an issue report from the particular renter may depend on one or more of the following: the renter's trustworthiness, bicycle renter history, bicycle renter maintenance feedback accuracy, bicycle renter frequency of use, bicycle renter average distance of use, bicycle renter average speed, other renters' reports, and accuracy of the renter's past reports as confirmed by maintenance providers performing the reported issues, sensor data, and visual observations by other renters. For example, when a maintenance tasks is completed, Renter Rating Module 156 may require the maintenance provider confirm the accuracy of the reported issue, i.e. whether the issue was as described in the one or more bicycle issue reports. If a renter has accurately reported the problem, the renter rating and the maintenance information weight of the renter is increased. If a maintenance provider reports that the issue was not as reported by the renter, then the renter rating and the maintenance information weight for that renter may be decreased.

At 208, the technique compares the calculated maintenance task confidence value to a predetermined task creation threshold in deciding whether to create a maintenance task. Task Creation Threshold database 118 may keep track of the task creation threshold value for each maintenance task for each bicycle. At 210, if the calculated maintenance task confidence value of a particular maintenance task for a particular bicycle is greater than the task creation threshold of the particular maintenance task, the technique creates a maintenance task at 214; and the technique ends at 216. At 210, if the calculated maintenance task confidence value is not greater than the task creation threshold, no maintenance task is created; and the technique ends at 218.

The technique may calculate maintenance task confidence values based on both the number of issue reports and the maintenance information weights assigned to these issue reports. The technique may require that three issue reports all having weights greater than a certain value, such as five before creating a maintenance task. When there are three such issue reports having maintenance information weights greater than five, the technique creates a maintenance task. Alternatively, the technique may create a maintenance task after receiving three issue reports reporting the same issue on a bicycle irrespective of maintenance information weights.

Alternatively, the technique may generate a maintenance task after receiving a certain number of issue reports where the sum of the maintenance information weights exceeds the task creation threshold. For example, the technique may require at least three issue reports and the task creation threshold may be fifteen. The technique creates a maintenance task when there are three issue reports for a particular issue on a particular bicycle and the sum of the maintenance information weights for the three reports is at least fifteen. So if a first renter reports a steering problem for a particular bicycle and the issue report has a maintenance information weight of ten, a second renter reports the same problem and the issue report has a maintenance information weight of three, and a third renter reports the same problem and the issue report has a maintenance information weight of three, then the technique creates a maintenance task for fixing the bicycle's steering problem.

Alternatively, the technique may generate a maintenance task upon receiving renter reports for a particular issue with a sum of maintenance information weights exceeding the task creation threshold. For example, the task creation threshold may be fifteen. When a first renter reports a steering problem for a particular bicycle and the issue report has a maintenance information weight of ten, and a second renter reports the same problem and the issue report has a maintenance information weight of six, then the technique will create a maintenance task for that issue regardless of the number of renters having reported the issue.

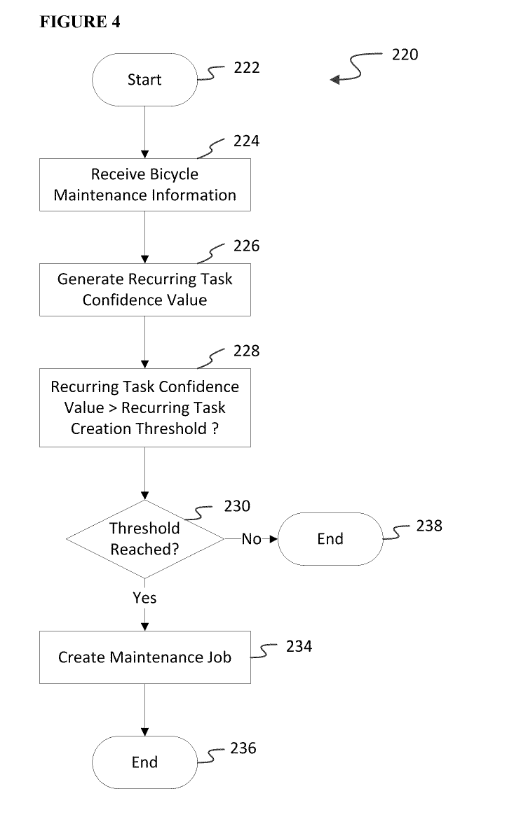

FIG. 4 is a flowchart illustrating technique 220, possibly employed by Task Creation Module 152, for creating maintenance tasks based on the need to perform recurring maintenance tasks. Technique 220 starts at 222. At 224, the technique receives information relating to when recurring maintenance tasks were previously performed. Recurring maintenance tasks are certain maintenance tasks that should be routinely performed on bicycles. Such recurring maintenance tasks may be suggested by bicycle manufacturers or mandated by the insurance provider of Bicycle Sharing System 40. At 226, the technique generates recurring task confidence values for the various recurring maintenance tasks of each bicycle managed by Bicycle Sharing System 40. The recurring task confidence value of a particular recurring task for a bicycle is based on when the particular recurring task was last performed on the bicycle. Recurring Task History database 120 may keep track of the previous performance of recurring maintenance tasks.

At 228, the technique compares the calculated recurring task confidence value to a predetermined recurring task creation threshold to decide whether to create a recurring maintenance task. Task Creation Threshold database 118 may keep track of the recurring task creation threshold values of each recurring maintenance task for each bicycle. At 230, if the calculated recurring maintenance task confidence value of a particular recurring maintenance task for a particular bicycle is greater than or equal to the recurring task creation threshold of the particular recurring maintenance task, the technique creates a recurring maintenance task at 234; and the technique ends at 236. At 230, if the calculated recurring maintenance task confidence value is not greater than the recurring task creation threshold, of the particular recurring maintenance task, no recurring maintenance task is created; and the technique ends at 238.

For example, every bicycle should receive a regular tune-up every ten months. For this recurring task, its recurring task confidence value at a particular time may be ((T_present_T_last_performance)/T_recommended_performance_interval), where T_present is the time when the technique considers whether to create the particular recurring maintenance task for the particular bicycle; T_last_performance is the time the particular recurring maintenance task was performed; and T_recommended_performance interval is the recommended interval for the particular recurring maintenance task. Thus, if a regular tune-up was performed nine and a half months ago for a particular bicycle, the recurring task confidence value for regular tune-up for this bicycle is 0.95. If the recurring task creation threshold is 0.9 for regular tune-up, the technique will create a recurring maintenance task of regular tune-up for that particular bicycle. If the recurring task creation threshold is 1 for regular tune-up, the technique will create a recurring maintenance task of regular tune-up only after the bicycle has not received a regular tune-up for more than ten months, the recommended interval for regular tune-up. Alternatively, recurring task confidence value may be exponentially-weighted.

The recurring task creation threshold may be adjusted periodically. For example, the recurring task creation threshold may be set at a lower value if a busy time of year is approaching and heavy bicycle usage is expected. This would increase the likelihood and frequency of recurring maintenance tasks being performed and ensure that more bicycles are operational during peak usage times.

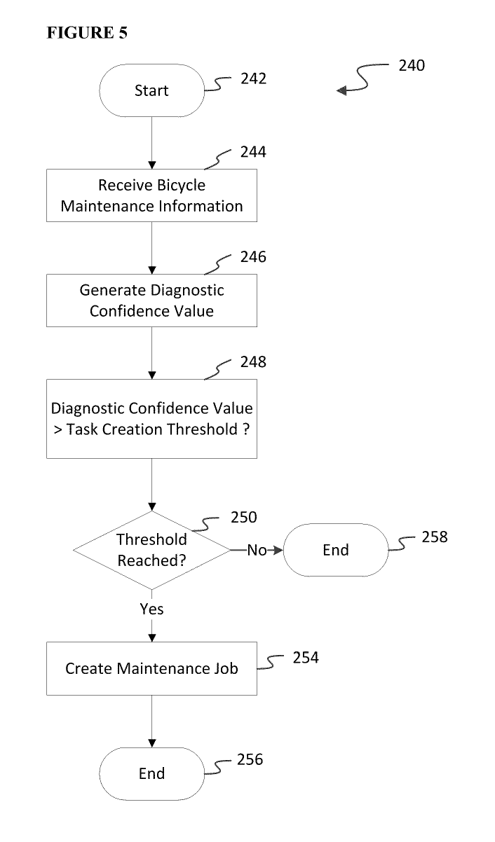

FIG. 5 is a flowchart illustrating technique 240, possibly employed by Task Creation Module 152, for creating maintenance tasks based on diagnostic confidence values. The technique starts at 242. At 244, the technique receives bicycle maintenance information. For example, Task Creation Module 152 may receive bicycle maintenance information related to the status of bicycles in Bicycle Sharing System 40. Bicycle maintenance information may include a bicycle being used less than expected based on its rental history, a bicycle being used less than expected based on rental trends and predicted usage, frequency of rental, bicycle mileage, bicycle age, maintenance history, and sensor data. Maintenance information may also include the time of year, day of the week, time of day, and weather history and forecast. Rental History Module 78 may track the rental history of each bicycle using Rental History database 104. Rental Trend Module 80 may determine the predicted rental trends for bicycles at every rental station. The Rental Trends database 106 may store predicted rental trends, past, present, and future. Electronic Control 58 of a bicycle may include one or more sensors that record sensor data such as G-force sustained by the bicycle the tire pressure of the bicycle. A G-force sensor in Electronic Control 58 may record the G-force sustained by the bicycle. An automatic tire pressure monitoring system connected to Electronic Control 58 may determine the tire pressure of the bicycle. The sensor data may be communicated to Bicycle Rental System 50 using Bicycle Interface Module 76.

At 246, the technique generates a diagnostic confidence value for each bicycle based on bicycle maintenance information received. A bicycle with a high diagnostic confidence value likely requires maintenance. For example, Task Creation Module 152 may use some or all of bicycle maintenance information received to create a diagnostic confidence value. Some bicycle maintenance information may increase the diagnostic confidence value that a maintenance task should be created while some bicycle maintenance information may decrease the diagnostic confidence value that a maintenance task should be created. For example, a bicycle being used less than expected may increase the diagnostic confidence value that a maintenance task should be created. And a vehicle being rented without a reported issue may decrease the diagnostic confidence value that a maintenance task should be created. In computing a diagnostic confidence value, the various types of bicycle maintenance information may be given different weights. Maintenance Information Weight database 112 may keep track of the various maintenance information weights determined by Maintenance Information Weight Module 154 for the various types of bicycle maintenance information in calculating diagnostic confidence values. Alternatively, maintenance information weights may be exponentially weighted.

At 248, the technique compares the calculated diagnostic confidence value to a predetermined diagnostic confidence threshold to determine whether to create a diagnostic maintenance task. At 250, if the calculated diagnostic confidence value is greater than the diagnostic confidence threshold, the technique creates a maintenance task at 254; and the technique ends at 256. At 250, if the calculated diagnostic confidence value is not greater than the task creation threshold, no maintenance task is created and the technique ends at 258. Task Creation Threshold database 118 may keep track of the threshold diagnostic confidence value for each maintenance task for each bicycle.

A maintenance task may be created when something is wrong with a bicycle and a trained maintenance provider is required to diagnose the repair. For example, if a bicycle has multiple issue reports of different issue report types, Task Creation Module 152 may create a maintenance task with an undetermined maintenance issue so that a maintenance provider visits the bicycle and diagnoses the specific problem.

The following is one example showing a technique of calculating a diagnostic confidence value:
B—Represents the binary state of brokenness for a bicycle. (B means broken; ˜B means not broken)
R—Represents the binary state of the existence of a maintenance request (report) on a given bicycle. R means a report has been filed, ˜R means a report has not been filed. Rⁿ will be used to indicate n or more reports exist (R≧n).
Pr(X)—Represents the probability of binary state “X.” By definition, Pr(X)+Pr(˜X)=1.
Pr(A|B)—Represents the conditional probability of A given that we observed B to be true. By definition, Pr(A|B)+Pr(˜A|B)=1.
Cₑᵥₑₙₜ Represents the cost of a particular event in arbitrary economic terms (dollars, time, utilities, etc.)

E( )—Represents the expectation value operator.

The technique may keep track of the following metrics:
Pr(B)—The a-priori probability that a bicycle is broken (B), e.g., the system-wide failure rate.
Pr(R)—The a-priori probability that a report is filed on a bicycle; the system-wide report rate.
Pr(R|B)—The a-priori probability that a report is filed given that the bicycle is broken. This is the report rate for broken bicycles. This statistic can also be calculated directly from 1—Pr(˜R|B), the rate of repairs performed on un-reported bicycles.

Task Creation Confidence database 116 may keep track of one or more of these metrics. From these metrics, the technique may use Bayes' Theorem to calculate the posterior likelihood of Pr(B|R), the likelihood that a bicycle is broken given that a report has been filed for it: Pr(B|R)=Pr(R|B)*Pr(B)/Pr(R). The technique may use Pr(B|R) as the diagnostic confidence value. In addition to establishing confidence about the brokenness of a given bicycle, the technique may also apply the same probabilistic methods to each different kind of report. For example, instead of calculating Pr(B|R), Task Creation Module may calculate Pr(B|Rᵢ), where i is a particular type of report.

The technique may also use the above method to account for miss-reporting of the particular failure that occurred, i.e., Pr(Bⱼ|Rᵢ). The technique may then generate a vector of probabilities Pᵢ=(Pr(B)|Rᵢ) for each report type. After each and every report is filed and a mechanic has been sent to triage the reported issue, the technique may recalculate Pr(B), Pr(R), and Pr(R|B). Therefore, the technique may adjust the posterior probabilities of failure based on information such as trends in failure and failure reporting.

The probability of a report, Pr(R), may be calculated by dividing the number of bicycles with outstanding issue reports, i.e. issue reports that have not been completed, by the number of total bicycles. Pr(R̂2) is calculated similarly by dividing the number of bicycles with two outstanding issue reports by the total number of bicycles. This can be generalized to any Pr(R̂n) as N(R̂n)/N, where N is the number of bikes and N(R̂n) is the number of bikes with ‘n’ outstanding issue reports.

The following is one example showing a technique of calculating and adjusting diagnostic confidence threshold:

Pr(B) has been determined to be 1.0% based upon historical observations that 1.0% of a particular bicycle fleet is broken at any given time. Pr (R) has been determined to be 3.0% based upon historical observations that 3.0% of a particular bicycle fleet has one or more outstanding failure reports at any given time. Pr(R²) has been determined to be 1.5% based on historical observations that 1.5% of a particular bicycle fleet has two or more outstanding failure reports at any given time. Pr(R|B) has been determined to be 95% based on historical observations that 95% of repairs performed on a particular fleet occurred due to at least one failure report. Then, the technique may calculate the probability that a bicycle is broken given that someone has filed a single report on it as:

$$Pr ( B \vert {R}^{1} ) = \frac{Pr ( {R}^{1} \vert B ) * Pr ( B )}{Pr ( R )} = \frac{0.95 * 0.01}{0.03} = 0.3167$$

This result shows that the report rate is triple the broken rate, and thus the technique has one-third confidence that a bicycle is broken given that an issue report is filed on it.

Furthermore, the technique may also adjust diagnostic confidence value as additional reports are filed:

$$Pr ( B \vert {R}^{2} ) = \frac{Pr ( {R}^{2} \vert B ) * Pr ( B )}{Pr ( {R}^{2} )} = \frac{0.95 * 0.01}{0.015} = 0.633$$

As shown, a second report increases the technique's confidence in the state of a bicycle. This method may be extended to an arbitrarily large number of reports. Also, rather than monitoring R as a binary condition, the technique may keep track of Rⱼ for many different types of reports. The technique may create a matrix R of probabilities indexed by issue report type and issue report frequency. Therefore, the technique may dynamically determine brokenness probabilities for different kinds of reports. The above procedure can be repeated for each Rⱼ.

In one embodiment, the technique uses Rental History Module 78 to monitor bicycle usage. Rental History Module 78 enables the technique to identify potential maintenance tasks even if no one reports such issues. For example, Rental History Module 78 may monitor one or more of the following: time between rentals at a given rental station, duration of rental, and average speed during rental. For example, a bicycle that are rented for shorter duration than average, a bicycle that has not been rented for longer than the average at the rental station where the bicycle is, or a bicycle that has an average speed that is below that of the average bicycle, in the system or in a similar situation, may increase the diagnostic confidence value that a maintenance task should be created.

The following is one example of a technique creating a maintenance task even though no issue report has been filed. The technique may assume that when a renter arrives at a rental station with N bicycles, the a-priori probability that the renter chooses any one bicycle is 1/N. Thus, the probability that a bicycle is rejected is

$$\frac{N - 1}{N} .$$

Then, the probability that a bicycle is rejected M times successively

$$( Pr ( {M}_{\vec{N}} ) is Pr ( B \text{\textbar} \text{\textasciitilde} R ) \approx Pr ( {M}_{\vec{N}} ) = {\prod }_{i = 1}^{M} \frac{{N}_{i} - 1}{{N}_{i}}$$

where Nᵢ is the number of bicycles at the station for the ith rejection. When this probability drops below a particular threshold (for example, 0.01%), the technique will have reasonably high confidence that the particular bicycle has something not working properly, as it is being rejected at an unreasonably high rate given the assumptions. The technique may extend this model to account for models in which it is not assumed, a-priori, that bicycles secured to different locations at a rental station have different checkout rate. The technique can calculate the checkout rates empirically from the history of each station once the system has been operating for a sufficiently long period of time.

Continuing with the above example, the technique may assume the following has been observed:
Zero bicycles are at a particular station;
Some time later, twelve bicycles have been checked into that station and the technique knows that each has Pr(M)=1;
Some time after that, eleven of the twelve bicycles from this station have been checked out, but one bicycle remains.

The technique may calculate the probability that the twelfth bicycle is not rented by chance, as opposed to it not being rented due to a maintenance problem:

$$Pr ( M ) = {\prod }_{i = 1}^{12} \frac{{N}_{i} - 1}{N} = {\prod }_{n = 12}^{2} \frac{n - 1}{n} = \frac{1}{12} .$$

If the technique requires a 95% confidence that there is something abnormal about a bicycle's checkout pattern before creating a maintenance task, then it may not create a maintenance task in this example. One the other hand, if, following the above events, two more bicycles were subsequently checked in and then checked out, the probability would fall to

$$\frac{1}{12} * \frac{1}{3} * \frac{1}{2} = \frac{1}{72} \approx 1.38 \%$$

and the technique may create a maintenance task for the bicycle.

One example of a technique calculating a diagnostic confidence value may require Task Creation Module 152 to consider the useful life of a particular bicycle part. While such useful life may be difficult to estimate accurately, Task Creation Module 152 may identify patterns in longevity that could inform the impending likelihood of part failure given the service lifetime of the part. Specifically, Task Creation Module 152 may calculate the “hazard rate” λ(t) empirically from system-wide part failure statistics. If a particular bicycle has a part with a large λ(t), Task Creation Module can create a maintenance task prior to the part is likely to fail, provided the tolerance for λ(t) is sufficiently large to prevent unnecessary repairs. Such as hazard rate can be calculated as follows:

$$λ ( t ) = f ( t ) * {( {\int }_{t}^{∞} f ( u ) d u )}^{- 1}$$

where f(t) is the (empirical) probability density function of part failure over time. One would expect λ(t) to be monotonically increasing over time, but large positive changes in λ(t) would indicate that a part was nearing the end of its service life. Parts with constant or near constant λ(t) (e.g., parts that fail randomly) would possibly not provide enough information for Task Creation Module 152 to perform preventive maintenance.

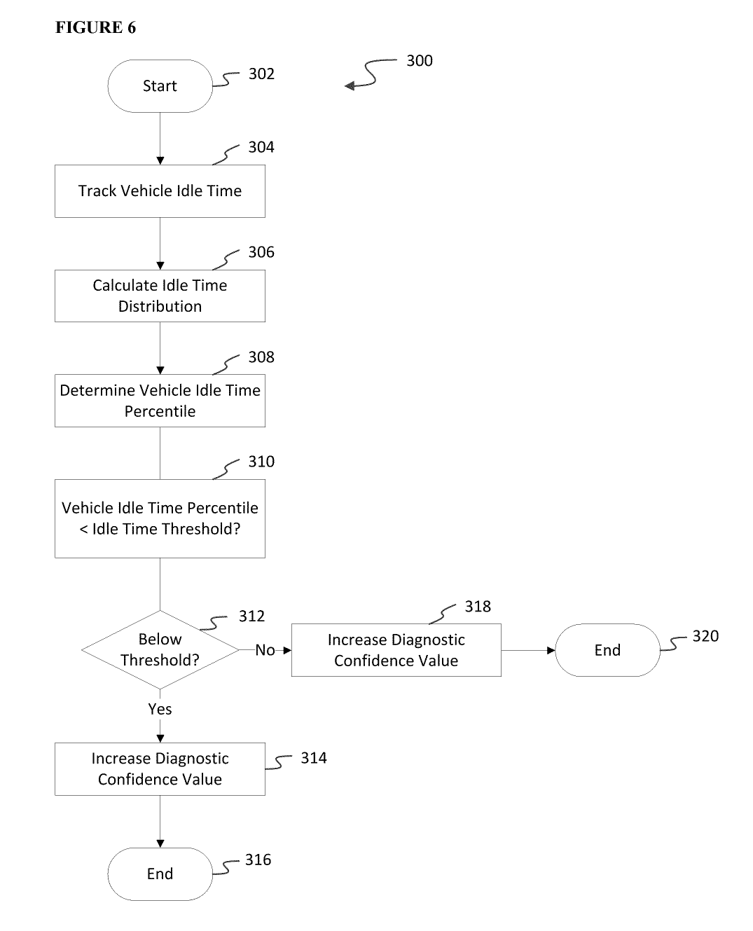

FIG. 6 is a flowchart illustrating technique 300, possibly employed by Task Creation Module 152, in creating maintenance tasks based on bicycle idle time. The technique starts at 302. At 304, the technique tracks how long each bicycle sits idle at a station. At 306, the technique calculates a distribution of bicycle idle time for all bicycles managed by Bicycle

Sharing System 40. At 308, the technique calculates the percentile of each bicycle's idle time in the distribution of bicycle idle time. At 310, the technique compares the each bicycle's calculated idle time percentile with an idle time threshold. If the individual bicycle's idle time percentile is below the idle time threshold, the technique at 314 increases the diagnostic confidence value that a maintenance task should be created for the bicycle; and the technique ends at 316. If the individual bicycle's idle time percentile is not below the idle time threshold, the technique at 318 decreases the diagnostic confidence value that a maintenance task should be created for the bicycle; and the technique ends at 320.

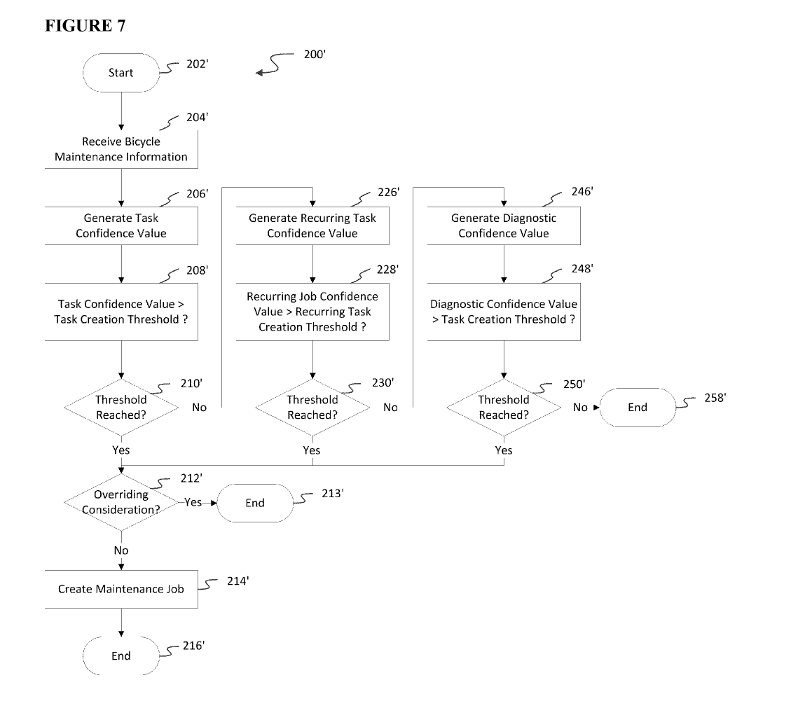

FIG. 7 is a flowchart illustrating technique 200, possibly employed by Task Creation Module 152, for creating maintenance tasks based on reported issues, the need to perform recurring maintenance tasks, and diagnostic confidence values. Technique 200′ illustrated in FIG. 7 combines the techniques illustrated in FIGS. 3, 4, and 5. Technique 200′ illustrated in FIG. 7 additionally considers overriding considerations in deciding whether to create a maintenance task.

At 212′, the technique may take into considerations other relevant information in deciding whether to generate a maintenance task even though a confidence value for a particular bicycle is greater than the threshold value. If there is one or more overriding consideration, the technique ends at 213′ even though a confidence value for a particular bicycle is greater than the threshold value. For example, even though the task confidence value based on issue reports may be greater than task creation threshold, the technique may not generate a maintenance task based on issue reports if that maintenance task is also a recurring task scheduled to be performed in the near future. This will avoid the maintenance task being performed more than necessary for the bicycle. If there is no overriding consideration at 212′, the technique creates a maintenance task at 214′; and the technique ends at 216′.

Another example of an overriding consideration is as the follows. There is some implicit cost in having a bicycle sits in a station in a state of disrepair, but there is also a cost to sending a maintenance provider or some other individual to check on the status of a bicycle. The following is one example of calculating each of these costs:

E[C_{B}]=C_{B}*Pr(B|R)

E[C_{-B}]=C_{-B}*Pr(˜B|R)

where C_{B} is the opportunity cost of a broken bicycle, and C_{˜failed} is the cost of sending a maintenance provider to a bicycle that has not failed.

$$E [ C ] = {\sum }_{i = 1}^{N} {C}_{i} * Pr ( {C}_{i} ) .$$

The technique considers costs associated with each outcome in determining whether to create a maintenance task. For example, if E(C_{failed})≧E(C_{˜failed}), then the technique creates a maintenance task for that bicycle or otherwise having an individual visit that bicycle to perform a visual inspection. E(C) may have units of time, dollars, or any arbitrary unit of economic value.

Continuing with the above example, if:
C_{B} is 30 minutes (e.g., the amount of user time assumed to have been wasted if one bicycle remains broken);
C_{˜B} is 45 minutes (e.g., the amount of extra maintenance provider time wasted if a maintenance provider is sent to a bicycle unnecessarily); and
R=1 (e.g., one generic report has been filed on a given bicycle).

Additionally, the technique may assume the probabilities in the prior example related in calculating confidence values. The expected cost of not sending out a mechanic to fix the bicycle is:

E[C_{B}]=30*0.3167≈9.5m

The expected cost of sending out a maintenance provider is:

E[C_{˜B}]=45*(1−0.3167)≈30.75m

Based on the above, the technique may not create a maintenance task or otherwise send an individual to visit the bicycle because the expected maintenance provider time wasted (about 31 minutes) is significantly greater than the expected customer time wasted (9.5 minutes). Similar calculations may be made with different units or different weightings based on a system operator's prioritization of maintenance provider time versus customer time.

Thresholds such as task creation threshold, recurring task creation threshold, and diagnostic confidence threshold may be set at E(C_failed)>=E(C_˜failed). Consequently, a maintenance task will be created if the expected economic cost of inaction is greater than the expected economic cost of action. The cost of action and inaction are dependent upon a number of factors, including the probability of brokenness and expected ridership fares. For example, if the certainty that a bike is broken is 10%, and a working bike nets $100 a day in ridership fees, then the expected cost of inaction is $10 per day, whereas the cost of action is 90% times the cost of dispatching a worker to check on the bike.

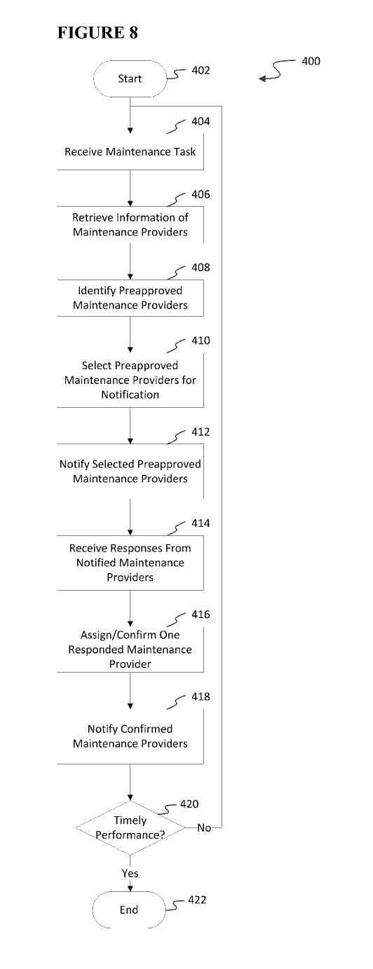

FIG. 8 is a flowchart illustrating technique 400, possibly employed by Notification Module 158, for selecting maintenance providers to perform maintenance tasks created by Task Creation Module 152. The technique starts at 402. At 404, the technique receives a maintenance task, possibly created by Task Creation Module 152. At 406, the technique retrieves information of maintenance providers, possibly stored in Maintenance Provider Information database 122. Based on the retrieved maintenance provider information, the technique identifies one or more maintenance providers preapproved for performing the particular maintenance task at 408. The technique may identify preapproved maintenance providers based on one or more of the following criteria: the maintenance task type, the difficulty level of the maintenance task, the priority and urgency of the maintenance task, the location of the bicycle requiring the performance of the maintenance task, the qualifications, capabilities, expertise, experience and trainings of maintenance providers, the ratings of maintenance providers, the locations of maintenance providers, and the average time required for each maintenance provider to complete all assigned maintenance tasks and the particular type of maintenance task. By setting very stringent criteria, very few maintenance providers, possibly only maintenance providers who are staff of the Bicycle Sharing System 40, are preapproved for performing the maintenance task. At 410, the technique may select all of the identified preapproved maintenance providers for notification by setting no selection criteria.

Alternative, at 410, the technique may select more than one and fewer than all of the identified preapproved maintenance providers to notify of the maintenance task. When selecting fewer than all of the identified preapproved maintenance providers for notification, the technique may consider the location of the bicycle requiring the performance of the maintenance task, the locations of maintenance providers, and the distance between the location of the bicycle requiring the performance of the maintenance task and the location of the identified preapproved maintenance providers. For example, preapproved maintenance providers within a certain threshold distance of the location of the maintenance task may be selected for notification. The threshold distance of the location of the bicycle requiring the performance of the maintenance task may be predetermined. Alternatively, the threshold distance may be dynamically determined while the technique selects preapproved maintenance providers for notification to ensure that a sufficient number of preapproved maintenance providers are selected for notification. The location of the preapproved maintenance provider may be determined by the GPS locations of maintenance providers. Smart Watch 185, Mobile Phone 186, Tablet 188, or Computer 190 that a maintenance provider carries may provide the GPS capability for determining the location of maintenance providers. Electronic Control 58 may contain a GPS unit that determines the location of the bicycle requiring the performance of the maintenance task.

Alternatively, at 410, the technique may select preapproved maintenance providers for notification based on one or more of the following: the difficulty level of the maintenance task, the qualifications of the identified preapproved maintenance providers, and the demand for bicycles at the rental station where the bicycle requiring the maintenance task is. The technique may also consider one or more of the following for each of the identified preapproved maintenance providers, possibly stored in Maintenance Provider Information database 122: the task history of the maintenance provider, the past performance and rating of the maintenance provider, the maintenance provider's status as a preferred provider, discounts offered by the maintenance provider, maintenance provider authorization, the relevant experience of the maintenance provider, the work history of the maintenance provider for Fleet Management and Maintenance System 150, the average time required for the maintenance provider to complete all assigned maintenance tasks and the particular type of maintenance task , and the maintenance provider's qualification, capability, expertise, experience, and training, the maintenance provider's performance in training and other tests, and the rating of the maintenance by renters and other maintenance providers performing verification tasks verifying the completion and qualify of previous maintenance tasks performed by the maintenance provider. The technique may consider maintenance provider ratings possibly determined by Maintenance Provider Rating Module 164 based on information of maintenance providers stored in Maintenance Provider Information database 122. And the maintenance provider ratings of some or all maintenance providers may be constantly declining at a slow rate to reflect skill atrophy for not performing maintenance tasks for a long duration.

The rating of a maintenance provider may be determined based on one or more of the following criteria: the qualification, capability, expertise, experience and trainings of the maintenance providers the timeliness of previous task completion, the ratings of previous maintenance tasks provided by renters and maintenance providers performing verification tasks for maintenance tasks completed by the maintenance provider, duration of the maintenance provider's relationship with Bicycle Sharing System 40, and the maintenance provider's performance in training and other tests. The different criteria may be given different weights in calculating maintenance provider ratings. And the calculation may have a time component such that a maintenance provider's performance in the distant past contributes less to the rating than the performance in the less distant past, i.e. time decaying.

At 412, the technique notifies the selected maintenance providers of the maintenance task. The technique may notify the selected maintenance providers via one or more of the following: emails, text messaging, social media, push notifications, mobile messaging, telephone, alerts displayed on information pages, alerts displayed in a smartphone application, and facsimile. The selected maintenance providers may access the notification using Smart Watch 185, Mobile Phone 186, Tablet 188, Computer 190, or one or more Kiosks at one or more rental stations. At 414, the technique receives responses from the one or more notified maintenance providers who have agreed to perform the maintenance task. The notified maintenance providers may respond using Smart Watch 185, Mobile Phone 186, Tablet 188, Computer 190, or one or more Kiosks at one or more rental stations.

If more than one of the notified maintenance providers have responded and indicated their willingness to perform the maintenance task, the technique selects and confirms one of the responded maintenance providers to perform the maintenance task at 416. When more than one of the notified maintenance providers have responded and indicated their willingness to perform the maintenance task, the technique may select and confirm the maintenance provider who has accepted the maintenance task first at 416. Alternatively, the technique may solicit bids from maintenance providers and then select and confirm one of the bidders, possibly the lowest bidder, at 416.

Alternatively, at 416, the technique may select and confirm responded maintenance providers taking into consideration one or more of the following: the difficulty level of the maintenance task, the qualifications of the identified preapproved maintenance providers, and the demand for bicycles at the rental station where the bicycle requiring the maintenance task is. The technique may also consider one or more of the following for each of the identified preapproved maintenance providers, possibly stored in Maintenance Provider Information database 122: the task history of the maintenance provider, the past performance and rating of the maintenance provider, the maintenance provider's status as a preferred provider, discounts offered by the maintenance provider, maintenance provider authorization, the relevant experience of the maintenance provider, the work history of the maintenance provider for Fleet Management and Maintenance System 150, the average time required for the maintenance provider to complete all assigned maintenance tasks and the particular type of maintenance task, and the maintenance provider's qualification, capability, expertise, experience, and training, the maintenance provider's performance in training and other tests, and the rating of the maintenance by renters and other maintenance providers performing verification tasks verifying the completion and qualify of previous maintenance tasks performed by the maintenance provider. The technique may consider maintenance provider ratings possibly determined by Maintenance Provider Rating Module 164 based on information of maintenance providers stored in Maintenance Provider Information database 122. And the maintenance provider ratings of some or all maintenance providers may be constantly declining at a slow rate to reflect skill atrophy for not performing maintenance tasks for a long duration.

At 418, the technique confirms with one of the responded maintenance providers who has been assigned to perform the maintenance task of the selection. The technique may notify the confirmed maintenance providers via one or more of the following: emails, text messaging, social media, push notifications, mobile messaging, telephone, alerts displayed on information pages, alerts displayed in a smartphone application, and facsimile. The responded and confirmed maintenance providers may access the confirmation using Smart Watch 185, Mobile Phone 186, Tablet 188, Computer 190, or one or more Kiosks at one or more rental stations.

At 420, if the maintenance provider does not complete the assigned and confirmed maintenance task within an allotted time threshold, the technique recreates the maintenance task by starting at 404. The failure to complete an assigned and confirmed maintenance task is recorded in Maintenance Provider Information database 122 and may result in the maintenance provider becoming unqualified to receive future maintenance tasks. If the maintenance task is timely performed, the technique ends at 422.

Maintenance Provider Rating Module 164 may determine the ratings of maintenance providers as follows. After a confirmed maintenance provider indicates to the Fleet Management and Maintenance System 150 that the confirmed maintenance task has been completed on the bicycle, Maintenance Provider Rating Module 164 determines whether the maintenance task has been performed satisfactorily. One or more of the renters who rent out the bicycle after the maintenance task has been completed may be asked to verify and rate the performance of the maintenance task. Maintenance Provider Rating Module 164 and Renter Interface Module 72 may ask the subsequent renter to complete a questionnaire or a survey. The renter may rate the prior repair using Electronic Control 58, Smart Watch 65, Mobile Phone 66, Tablet 68, Computer 70, a Kiosk at a rental station, email, web application, or mail. If the maintenance task has been performed satisfactorily, then Maintenance Provider Rating Module 164 will increase the rating of that maintenance provider. If the maintenance task was not performed satisfactorily, then Maintenance Provider Rating Module 164 will decrease the rating of that maintenance provider.

For every maintenance task, Maintenance Provider Incentive Module 166 may determine the nature and amount of an incentive or reward for the assigned and confirmed maintenance provider to perform the maintenance task based on one or more of the following: the task history of the maintenance provider, the past performance and rating of the maintenance provider, the maintenance provider's status as a preferred provider, discounts offered by the maintenance provider, maintenance provider authorization, the relevant experience of the maintenance provider, the work history of the maintenance provider for Fleet Management and Maintenance System 150, the average time required for the maintenance provider to complete all assigned maintenance tasks and the particular type of maintenance task , and the maintenance provider's qualification, capability, expertise, experience, and training, the maintenance provider's performance in training and other tests, and the rating of the maintenance by renters and other maintenance providers performing verification tasks verifying the completion and qualify of previous maintenance tasks performed by the maintenance provider. The technique may consider maintenance provider ratings possibly determined by Maintenance Provider Rating Module 164 based on information of maintenance providers stored in Maintenance Provider Information database 122.

A reward or incentive may be monetary or a maintenance provider's preferred status. More complex tasks may have a higher incentive. If a maintenance provider has a poor maintenance provider rating, the maintenance provider may be rewarded less than if the maintenance provider has a history of performing quality work. If a created maintenance task has a lower confidence value, the maintenance provider may be offered a lower incentive because no work may be required. If a task is completed in a quality and timely manner, the maintenance provider may be rewarded for performing the task well fast. If a maintenance provider has maintenance provider rating greater than a threshold, then Maintenance Provider Incentive Module 166 may generate a higher reward or an extra reward for the maintenance provider for performing the task well. If a maintenance provider has maintenance provider rating below a threshold, then Maintenance Provider Incentive Module 166 penalizes the maintenance provider for performing the task poorly, for example, by removing the maintenance provider's preferred status.

Maintenance Verification Module 162 may determine the necessity of creating a verification task. If the maintenance provider who has performed the maintenance task has a maintenance provider rating below a set threshold, Maintenance Verification Module 162 may create a verification task.

Alternatively, Maintenance Verification Module 162 may consider the complexity of the maintenance task and the expertise level of the maintenance provider, possibly stored in Maintenance Provider Information database 122 in deciding whether to create a verification task. Task database 110 may keep track of the difficulty of all maintenance tasks. For example, the expertise level of the maintenance provider may be a number between 1 and 10, with a higher number indicating more experience. A maintenance task complexity may be a number between 1 and 10, with a higher number indicating more complexity. Maintenance Verification Module 162 calculates the need to create a verification task by dividing the maintenance task complexity by the maintenance provider expertise. If the result is above a certain threshold, for example 1, then Maintenance Verification Module 162 creates a maintenance task.

The threshold for creating a verification task may be based on one or more of the following: maintenance information weights, issue report weights, the frequency with which maintenance tasks are created, past weather and weather forecast sensor data, time of day, day of the year, or location. For example, if the time of year is such that there is likely to be heavy use of a particular bicycle in the near future, then Maintenance Verification Module 162 may decrease the threshold for creating a verification task so that it is more likely that a verification task is created.

A verification task may request another maintenance provider to confirm that the maintenance task has been satisfactorily completed. Alternatively, a verification task may request the next bicycle renter to confirm the maintenance task has been satisfactorily completed. Alternatively, the bicycle may have sensors that are able to confirm that the maintenance task has been satisfactorily completed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus, such as a processing circuit. A processing circuit such as CPU 258 or 234, for example, may comprise any digital and/or analog circuit components configured to perform the functions described herein, such as a microprocessor, microcontroller, application-specific integrated circuit, programmable logic, etc. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and an I/O device, e.g., a mouse or a touch sensitive screen, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A fleet management and maintenance system comprising:
a task creation module configured to:
receive vehicle maintenance information for a vehicle from a plurality of vehicle maintenance information sources;
generate a maintenance task confidence value corresponding to a probability that a vehicle requires maintenance, wherein the probability that the vehicle requires maintenance is determined based on the received vehicle maintenance information;
compare the maintenance task confidence value to a task creation threshold; and
create a maintenance task in response to the maintenance task confidence value satisfying the task creation threshold; and
a notification module configured to assign the maintenance task to one maintenance provider of a plurality of maintenance providers based on a difficulty level of the maintenance task and a capability rating of the one maintenance provider.

2. The fleet management and maintenance system of claim 1, wherein at least one source of the plurality of vehicle maintenance information sources comprises crowd-sourced user feedback information received from one or more remote renter interfaces.

3. The fleet management and maintenance system of claim 1, wherein at least one source of the plurality of vehicle maintenance information sources comprises a vehicle sensor.

4. The fleet management and maintenance system of claim 3, wherein the vehicle sensor comprises at least one of a sensor configured to measure at least one of brake performance, mileage, tire pressure, acceleration, vibration, shock sustainment, and weather exposure.

5. The fleet management and maintenance system, further comprising a maintenance verification module configured to verify completion of the maintenance task based on feedback received from a subsequent renter of the vehicle.

6. The fleet management and maintenance system of claim 1, wherein the task creation module is further configured to create a recurring maintenance task for the vehicle based on information indicating when past maintenance tasks were performed on the vehicle.
